(19) United States
(12) Patent Application Publication
(10) Pub. No.: US 2005/0159286 A1
(43) Pub. Date: Jul. 21, 2005

(54) Folding machine for folding a contiuous web material and folding method

(75) Inventors: Alessandro Morelli, Lucca (IT); Mauro Gelli, Lucca (IT)

Correspondence Address: BREINER & BREINER, 115 NORTH HENRY STREET, P. O. BOX 19290, ALEXANDRIA, VA, 22314, US

(73) Assignee: Fabio Perini S.P.A. Zona Ind. le P.I.P., Lucca (IT)

(21) Appl. No.: 10/510,570

(22) PCT Filed: Feb. 9, 2004
(86) PCT No.: PCT/IT04/00050

(30) Foreign Application Priority Data
Feb. 12, 2003 (IT) FI2003A000037

(51) Int. Cl. B31F 1/00

(52) U.S. Cl. 493/405

(57) ABSTRACT

The folding machine includes at least one folding rollers (1, 3; 505) provided with a least one gripping member (43; 513) to mechanically grip the web material (N) along a folding line. A suction member (79; 515) is associated with the gripping member (43; 513) to draw the web material towards said gripping member (43; 513).

### TECHNICAL FIELD

The present invention relates to a folding machine to fold a web material along transverse folding lines. More specifically, the invention relates to a folding machine of the type comprising a pair of counter-rotating folding rollers, placed side by side and with axes parallel, each of which has at least a gripping member to grasp the web material along transverse lines and make folds along said lines.

The invention also relates to a means to folding a continuous web material according to transverse zigzag lines.

### STATE OF THE ART

In many folding machines used in the paper converting field to produce for example folded paper napkins, 6 continuous web material—which may be previously folded according to a longitudinal line—is fed to a pair of counter-rotating folding rollers, arranged with parallel axes and side by side with each other to define a nip through which the web material is fed. Disposed on each roller are members that make the fold in the web material. The aforesaid members are disposed and controlled so that the web material is folded in zigzags, adhering alternately first to one and then to the other of the two counter-rotating folding rollers. The pack formed of the web material folded in a zigzag is then cut by a blade and divided into two rows of paper napkins or similar folded products.

A machine of this type is described for example in WO-A-9728076 and in WO-A-0162651. Other examples of folding machines are described in U.S. Pat. No. 3,195,882, in U.S. Pat. No. 3,229,974, in U.S. Pat. No. 3,820,774, in U.S. Pat. No. 3,689,061, in German patent 4,446,753 and in German patent 429,288.

The folding members of these folding machines include on each folding roller a gripping member which with each turn, of the roller grips the web material along a folding line. To insert the web material into the gripping member, respective folding blades or wedges are located on the two folding rollers, in positions angularly staggered with respect to the gripping members. To make a fold a folding blade of one of the two folding rollers and a gripping member of the other folding roller are in angular positions so that they come to correspond with each other in the nip defined between the two folding rollers, and the web material is pushed by the folding blade inside the gripping member.

Typically, each of the two folding rollers has at least one folding blade and one gripping member, so that for each complete turn of the pair of folding rollers at least two folds are made on the web material.

The presence of folding blades and gripping members on the counter-rotating folding rollers makes these machines particularly complex from a mechanical viewpoint. Moreover, the mechanical action of the folding blade or wedge on the web material tends to damage it. The folding blades are subject to rapid wear with consequent maintenance costs.

### OBJECT AND SUMMARY OF THE INVENTION

The object of the present invention is to produce a folding machine of the aforesaid type, which is simpler, but at the same time efficient and reliable.

This and further objects and advantages, which shall be apparent to those skilled in the art by reading the text hereunder, are obtained essentially with a folding machine comprising in combination: at least one folding roller with at least one mechanical gripping member to grasp the web material; associated with said at least one gripping member, a gaseous flow member, such as an air flow member to insert the web material towards said gripping member.

According to a first embodiment, the gas or air flow member includes a suction member to pull the web material towards or in said gripping member.

According to a different embodiment, the gas or air flow member includes an air ejection member, to generate a flow of compressed air to push the web material towards or in said gripping member.

In practice, two counter rotating folding rollers may be arranged side by side, each provided with one or more gripping members.

With an arrangement of this type the web material is inserted into the gripping member by the effect of suction, without requiring to provide a folding blade on the opposed folding roller. This considerably simplifies the machine structure, as only gripping members with the respective suction system are provided on each folding roller, it being no longer necessary to provide the folding blades. Moreover, the suction effect is less likely to damage the web material with respect to the mechanical action of usual folding blades, in particular when extremely soft or embossed products are processed, which are easily marked by the action of mechanical members.

It is also achieved the advantage of greater operating tolerance, with respect to an entirely mechanical folding machine, wherein much greater precision is required to synchronize the movements of the folding blade with respect to the gripping member. On the contrary, by using suction to make the web material penetrate the gripping member, even noteworthy approximations are acceptable in synchronizing the movements.

In practice, to obtain correct and reliable operation and reduce consumption, each of the suction members is associated with a device to activate and deactivate suction as a function of the angular position of the respective folding roller, the suction member of each folding roller being active for a fraction of a complete turn of the respective folding roller.

Each of the gripping members can include a movable element cooperating with a first stop, said suction member using suction to position the web material between said movable element and said stop. For this purpose, suitable devices can be provided to limit the effect of suction to the desired zone. In practice, each of the folding rollers can be provided with at least one cavity essentially parallel to its axis of rotation and open on the cylindrical surface of the folding roller, inside which the respective gripping member is housed, with a suction duct, which is part of the respective suction member, terminating in said cavity. In this case each of said cavities are advantageously provided with means to limit the effect of suction on one side of the movable element, between it and said first stop. For this purpose, a first block defining the first stop with which the respective movable element cooperates can, for example, be fixed in each cavity. This first block delimits a suction compartment in connection with the suction duct and is provided with a plurality of suction holes distributed along the longitudinal extension of said first block and terminating on a surface of said block positioned on the opposite side with respect to said suction compartment and facing the movable element. This surface may be specifically shaped to form a sealing surface cooperating with an oscillating shaft forming part of the movable element. The holes are in this case disposed between the first stop defined by said block and said sealing surface.

To connect each rotating folding roller to a fixed suction line, each of said folding rollers may advantageously be associated with a sliding block with a connecting channel between said suction line and a suction duct in the respective folding roller. This sliding block rests on a sliding surface provided on the folding roller, typically and advantageously on one of the two faces of the roller and in particular preferably the upper surface.

The sliding block may advantageously be resiliently pushed against said sliding surface produced on the respective roller. It may have an elongated aperture communicating with the respective folding roller.

The devices to activate and deactivate suction can be adjustable, to adjust the opening and closing position of suction as a function of the angular position of the respective folding roller. For this purpose, when a sliding block is provided to pneumatically connect the folding roller with a suction line, this sliding block can be designed so that it is disposed in a specific angular position adjustable in respect of the relative folding roller, so as to adjust the positions in which suction starts and stops.

If an air ejection member is used to push the web material towards the gripping member, said air ejection member can be arranged on the surface of one folding roller or of a roller parallel and adjacent to a folding roller, in a position phased with the position of the gripping member on the opposed folding roller, such that the air ejection member passes in front of the gripping member in correspondence of the nip formed between the folding rollers while the rollers rotate. A gripping member and an air ejection member, arranged in diametrically opposed positions, can be provided on each folding roller when the machine includes two parallel and adjacent folding rollers.

Further advantageous features and embodiments of the machine according to the invention are indicated in the appended dependent claims.

According to a different aspect, the invention relates to a method for folding a web material according to transverse folding lines, comprising the steps of:
providing at least one folding roller provided with at least one mechanical gripping member;
rotating the folding roller feeding the web material to it;
engaging the web material with said at least one gripping member.

Characteristically, according to the invention the web material is inserted into the respective gripping members by an air flow, such as by suction.

In practice, two folding rollers may be provided, placed side by side and provided with gripping members that grip the web material alternately, to fold it in a zigzag.

Further advantageous characteristics of the method according to the invention are indicated in the appended claims and shall be described with reference to the accompanying drawings.

### BRIEF DESCRIPTION OF THE DRAWINGS

The invention shall now be better understood by following the description and accompanying drawing, which shows non-limiting embodiments of the invention. In particular, in the drawing:

FIG. 1 shows a front view of the machine with the respective pair of folding rollers;

FIG. 2 shows a plan view according to line II-II in FIG. 1;

FIG. 3 shows a side view and partial longitudinal section of one of the two folding rollers, without the internal members;

FIG. 4 shows a longitudinal section of a portion of the folding roller with the gripping members mounted thereon;

FIG. 5 shows a section according to line V-V in FIG. 1;

FIG. 6 shows a section according to line VI-VI in FIG. 1;

FIG. 7 shows an enlarged longitudinal section of the suction zone of one of the folding rollers;

FIG. 8 shows a detail of the plan view of the assembly flange of the suction unit including the sliding block;

FIG. 9 shows a front view of one of the blocks forming the stop for the movable element of the gripping member;

FIGS. 10 and 11 show cross sections according to lines X-X and XI-XI in FIG. 9;

FIG. 12 shows a section according to line XII-XII in FIG. 7;

FIGS. 13A to 13C show three different angular positions of the folding rollers in the phase to make a fold in the web material, in a section orthogonal to the axes of rotation of the rollers;

FIG. 14 shows a schematic and plan view of a modified embodiment of the invention;

FIGS. 15A and 15B schematically show in a view equivalent to the view in FIG. 5, an improved embodiment of the invention;

FIGS. 16A, 16B and 16C show a schematic enlargement of the folding zone in three successive moments of the folding operation in the embodiment of FIGS. 15A and 15B; and

FIGS. 17A, 17B show the folding zone in two successive moments of the folding operation in a different embodiment, where a flow of compressed air is used to push the web material towards the gripping member.

### DETAILED DESCRIPTION OF THE PREFERRED EMBODIMENTS OF THE INVENTION

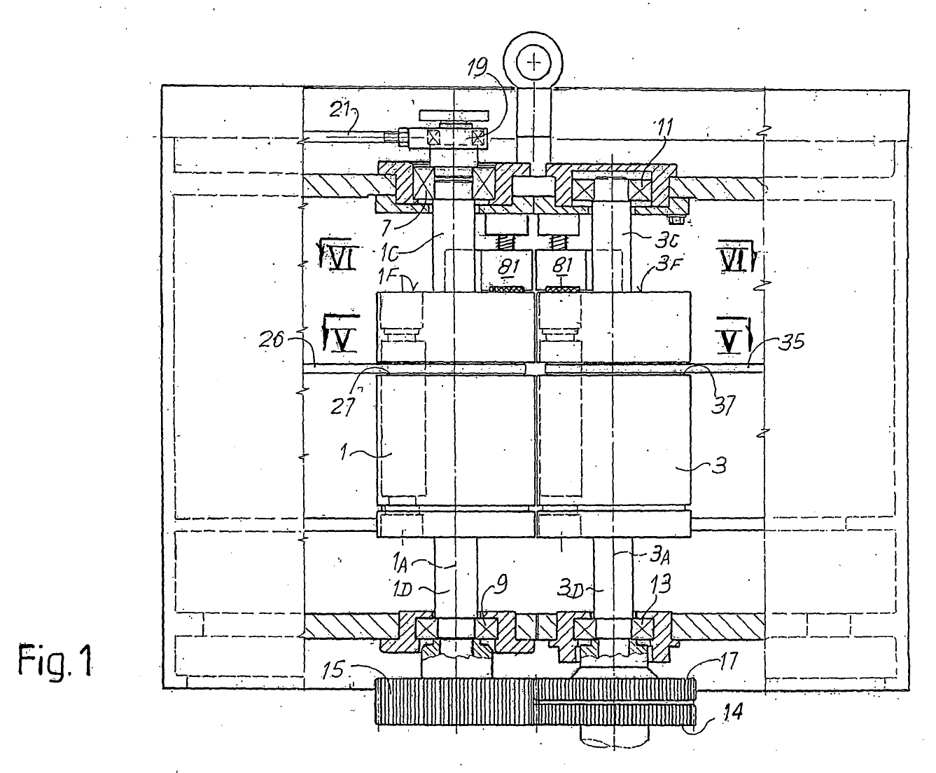

With initial reference to FIG. 1, the folding machine has a pair of folding rollers 1 and 3 rotating around respective vertical axes of rotation 1A and 3A, arranged parallel to each other and at a distance such that the two folding rollers 1, 3 are placed side by side at a nip 5. The folding roller 1 is supported by means of tangs 1C and 1D in corresponding supports 7, 9. The folding roller 3 is supported analogously by tangs 3C and 3D in supports 11 and 13.

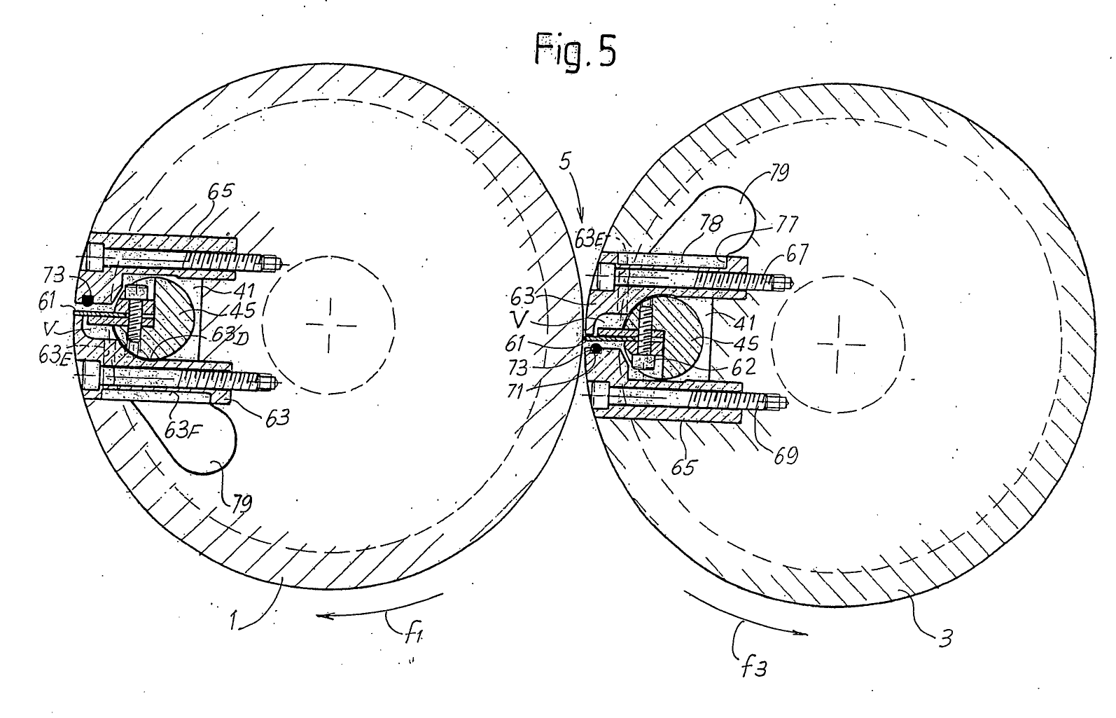

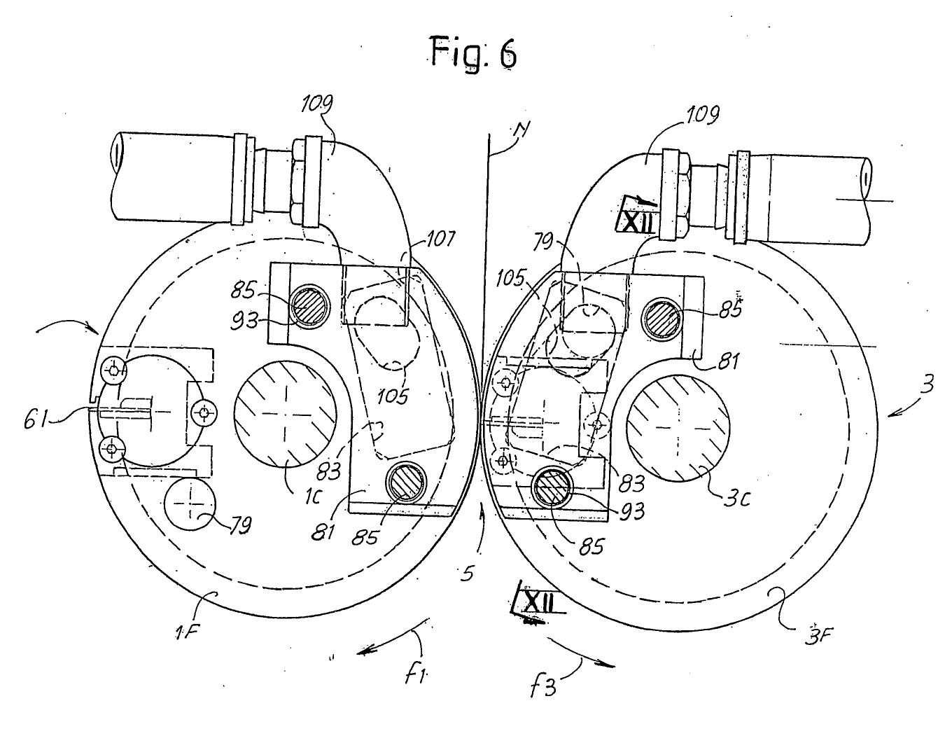

The two folding rollers 1 and 3 are carried in rotation in opposed directions (arrows f1 and f3 in FIGS. 5 and 6) by means of a toothed wheel 14 that meshes with a toothed wheel 15 keyed onto the shaft of the folding roller 1, and which in turn meshes with a toothed wheel keyed onto the shaft of the folding roller 3.

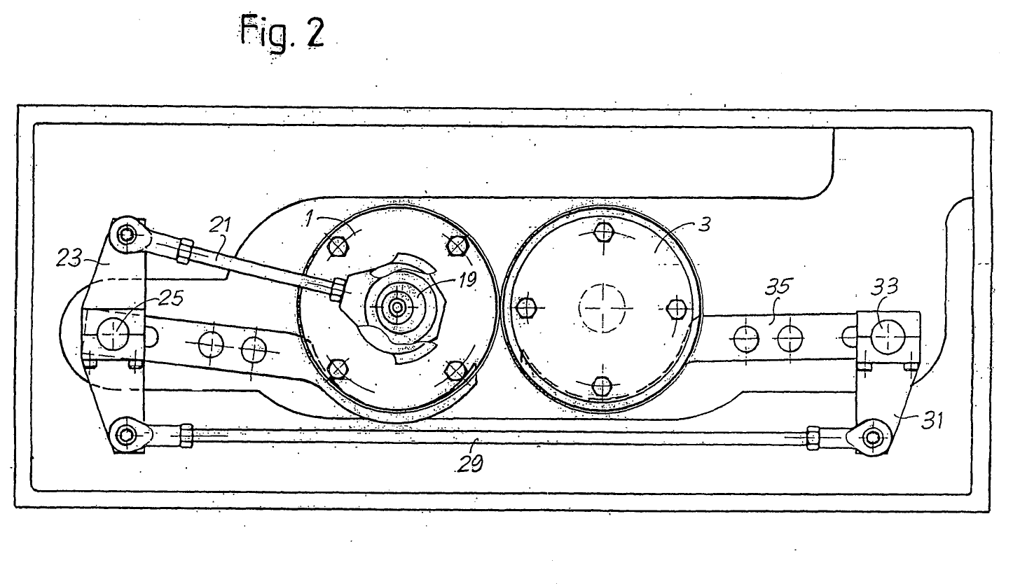

Mounted at the upper end of the shaft 1C of the folding roller 1 is an eccentric 19 that, by means of a rod 21, supplies an alternate movement to a rocker arm 23 (see FIG. 2). The rocker arm 23 is keyed onto a vertical shaft 25, parallel to the axes of two folding rollers 1, 3 and carries integral with it a shaped plate 26 that is inserted into an annular groove 27 in the folding roller 1.

Coupled to the rocker arm 23, at the opposite end with respect to the coupling of the rod 21, is another rod 29, the opposite end of which is hinged to a bracket 31 keyed onto a shaft 33, parallel to the shaft 25. Integral with the shaft 33 is a plate 35, analogous to the plate 26 integral with the shaft 25, and which is inserted into a groove 37 provided in the folding roller 3.

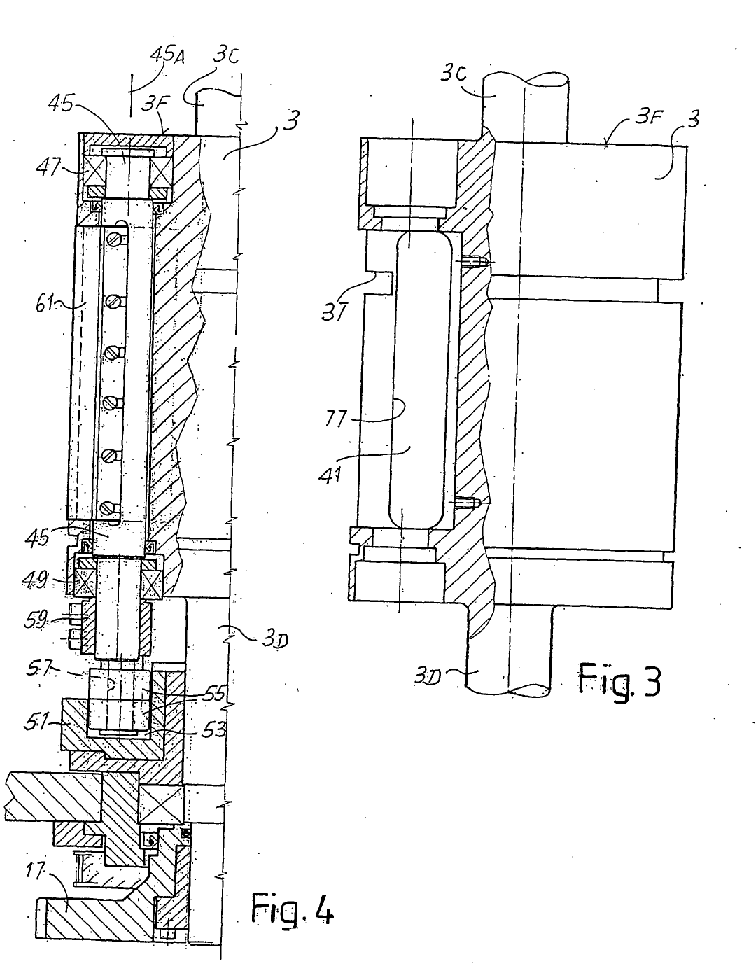

As can be seen in particular in the section in FIG. 5 and, limited to the folding roller 3, in the section in FIG. 3, longitudinal seats or cavities, indicated generally with 41 for both rollers, are produced inside the two folding rollers 1, 3. The two cavities are symmetrical with each other as can be seen in particular in FIG. 5 and the folding rollers are synchronized with each other so that the cavities are in diametrally opposite positions.

The cavities 41 terminate on the cylindrical surface of each of the two folding rollers 1, 3. Housed in each of the two seats or cavities of each folding roller 1, 3 is a gripping member indicated as a whole with 43, which is used to grip and fold the web material N fed into the nip 5 between the two folding rollers 1, 3. The two gripping members 43 are symmetrical with each other and only one of them will be described in detail hereunder.

The gripping member includes, as can be seen in particular in FIG. 4, a shaft with an oscillation axis 45A parallel to the axis of rotation of the respective folding roller. The shaft 45 is supported by bearings 47 and 49 housed in the respective folding roller.

The shaft is provided with an oscillating movement around its axis, controlled by means of a cam 51 which has a channel 53 inside which a wheel or feeler 55 engages, keyed onto a spindle 57 connected by means of a bracket 59 to the shaft 45 (see in particular FIG. 4). With this arrangement the cam 51, which is fixed in respect of the machine structure, controls oscillation of the wheel 55 and of the respective spindle 57 around the axis of oscillation 45A of the shaft 45, which will consequently be carried in rotation in turn.

A strip 61 is integral with the shaft 45, fastened to said shaft 45 by means of screws 62. The strip 61 extends radially until reaching approximately the cylindrical surface of the respective folding roller 1 or 3. When the cam with the channel 51 makes the shaft 45 oscillate around its axis, the strip 61 oscillates between two positions defined by two stops formed by a first block indicated as a whole with 63 and by a second block indicated as a whole with 65. The two blocks 63, 65 are housed in the seat or cavity 41 of the respective folding roller.

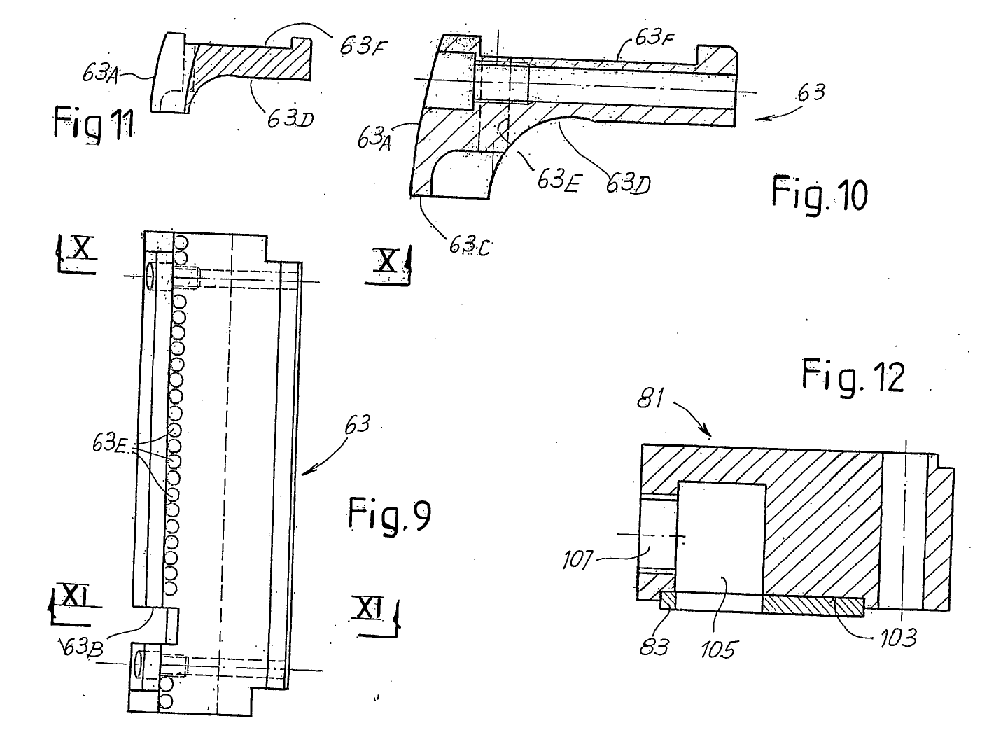

The first block 63, shown in greater detail in FIGS. 9 to 11 and described hereunder, is fixed to the respective folding roller by means of screws 67, while the block 65 is fixed to the roller by means of screws 69. The blocks 63 and 65 extend longitudinally, parallel to the axis of the respective folding roller, for approximately its entire height and therefore involve the entire axial extension of the cavity 41. The block 65 has a longitudinal groove 71 housed inside which is a rectilinear gasket 73 with a circular cross section, which forms an elastic stop for the strip 61.

With reference in particular to FIGS. 5, 9, 10 and 11, the block 63 has a cylindrical surface 63A Which, when the block is mounted in the respective folding roller, is flush with the cylindrical surface of the folding roller. This cylindrical surface is interrupted by a groove 63B, at the annular groove 37 or 27 of the folding roller 3 or 1.

Along one of the edges delimiting the cylindrical surface 63A of the block 63 a stop surface 63C is formed; when the block is mounted in the respective folding roller, this surface is positioned in front of the gasket 73 of the block 65. On the same side of the stop surface 63C, the block 63 has a second cylindrical surface 63D the curvature radius of which is essentially equivalent to the curvature radius of the cylindrical surface of the shaft 45. As can be seen in particular in FIG. 5, in fact, the shaft 45 practically grazes the cylindrical surface 63D of the block 63 for the purposes to be clarified hereunder.

The block 63 also has a plurality of through holes 63E that allow the two opposed faces of the block to communicate: the face on which the cylindrical surface 63D is produced and the back face on which a flat part 63F is produced. When mounted, the flat part 63F faces an elongated aperture 77 (see in particular FIG. 3) communicating with a suction member comprising a suction duct 79 produced in the body of the respective folding roller and terminating on the upper flat surface thereof. Therefore, a suction compartment 78 is defined between the flat part 63F and the suction duct 79.

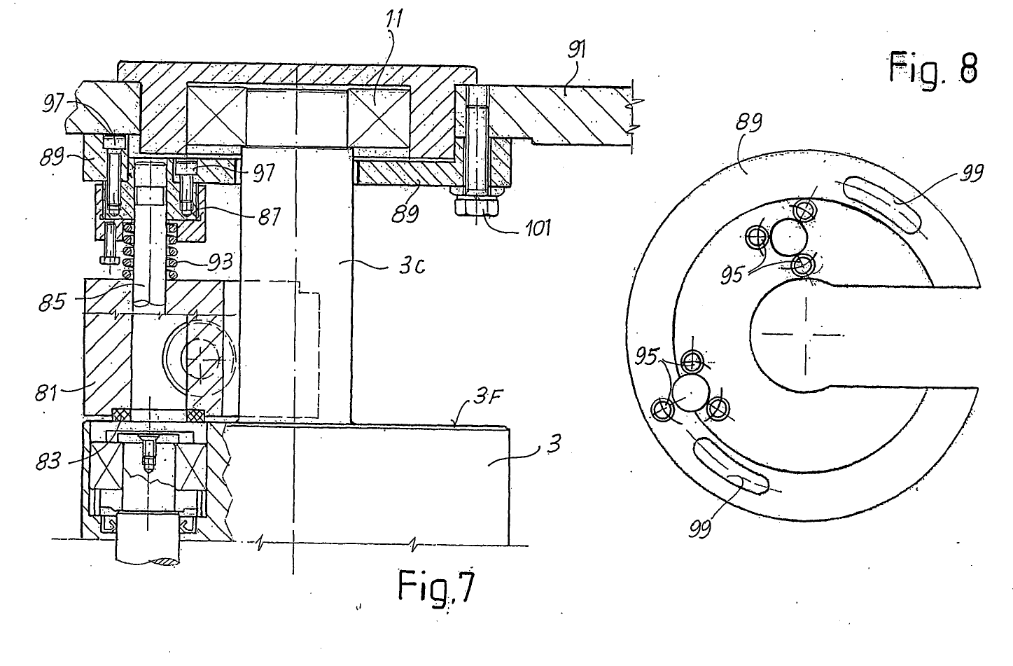

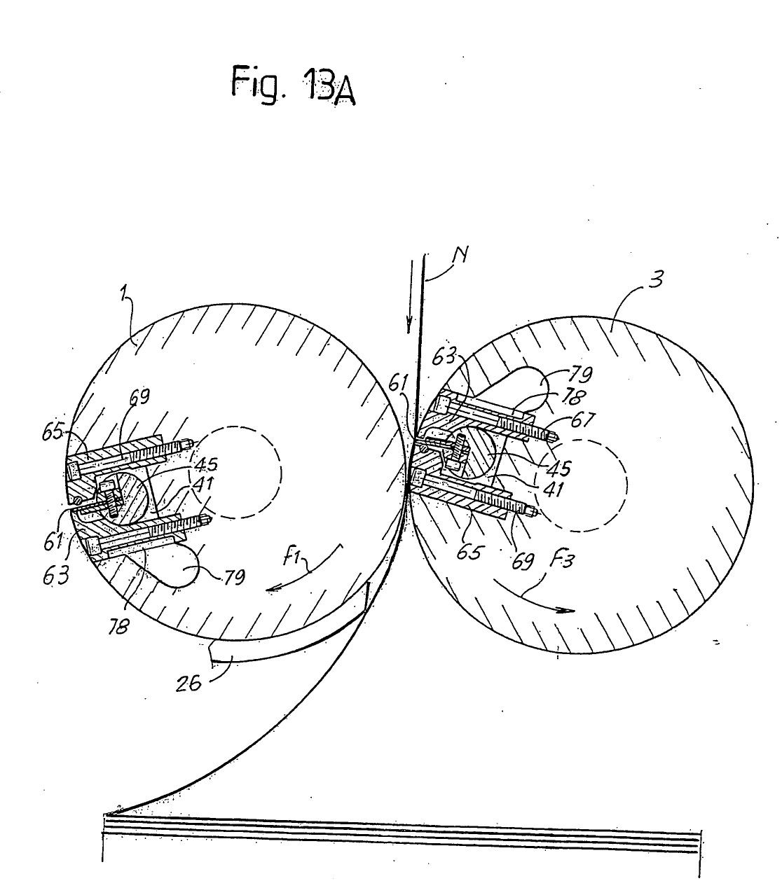

The suction ducts 79 of the two folding rollers 1, 3 are connected (in the way to be described in detail hereunder with reference to FIGS. 7 and 12) to suction means that produce a vacuum in a part of the cavity 41 of the respective folding roller for the purposes described hereunder.

The suction duct 79 communicates with the surface of the block 63 facing the strip 61 through the through holes 63E. With this arrangement, by means of the suction duct 79 (when a vacuum is formed in it) a vacuum is created in the volume delimited by the strip 61 with the relative support, by the shaft 45 and by the face of the block 63 facing the strip 61. This volume is indicated with V in FIG. 5.

To connect the suction duct 79 of each of the two folding rollers 1, 3 to the suction, for example a line connected to a fan, a connecting arrangement is provided cooperating with the upper front or base surface of each of the two rollers, indicated with 1F for the folding roller 1 and with 3F for the folding roller 3. This arrangement is shown in detail in FIG. 7 for the folding roller 3. The folding roller 1 has a symmetrical arrangement.

The end of the respective suction duct 79 terminates on the front surface 1F and 3F of each of the two folding rollers 1 and 3. A sliding block 81 also rests on said front surface, by means of a plate 83 in a material with a low coefficient of friction. The sliding block 81 is slidingly engaged to two guide columns 85 blocked vertically in respective couplings 87. These couplings are in turn fixed to a flange 89 attached to a portion 91 of the fixed structure of the machine. Two compression springs 93 (one of which can be seen in FIG. 7), stress the sliding block 81 against the front surface of the respective folding roller 1 or 3.

The flange 89 is shown in a plan view in FIG. 8. The number 95 indicates two threesomes of holes of the fixing screws 97 of the retaining couplings 87 for the guide columns 85. As can be seen in FIG. 8, the flange 89 is provided with two curved slots 99. Two screws (one of which is indicated with 101 in FIG. 7) are inserted in these to fix the flange 89 to the machine structure 91. Thanks to the curved slots 99, by loosening the screws 101 it is possible to adjust the angular position of each flange 89 with respect to the axis of the relative folding roller 1 or 3. In this way the angular position of the respective sliding block 81 can be adjusted.

The structure of the sliding block 81 is shown in detail in FIGS. 6 and 12. It has a main body in which a lowered seat 103 is made, inside which the plate 83 is housed. The main body and the plate 83 of the sliding block 81 have a hole with an oblong section 105, which extends parallel to the axis of the folding rollers 1 and 3. The oblong hole 105 is joined to a lateral hole 107 connected to a suction tube 109 in turn connected to a fan or another suitable suction member, not shown.

With this arrangement, when the folding roller 1 or 3 rotates around its axis, suction is produced inside the suction duct 79 for the entire arc of rotation of the roller along which the inlet of the suction duct 79, located on the frontal surface of the respective folding roller, is in flow connection with the oblong hole 105 formed in the sliding block 81. As the angular position of the flange 89 can be adjusted, this allows adjustment of the angular positions at which suction starts and stops inside the suction duct 79.

The folding machine described hereinbefore operates in the following way.

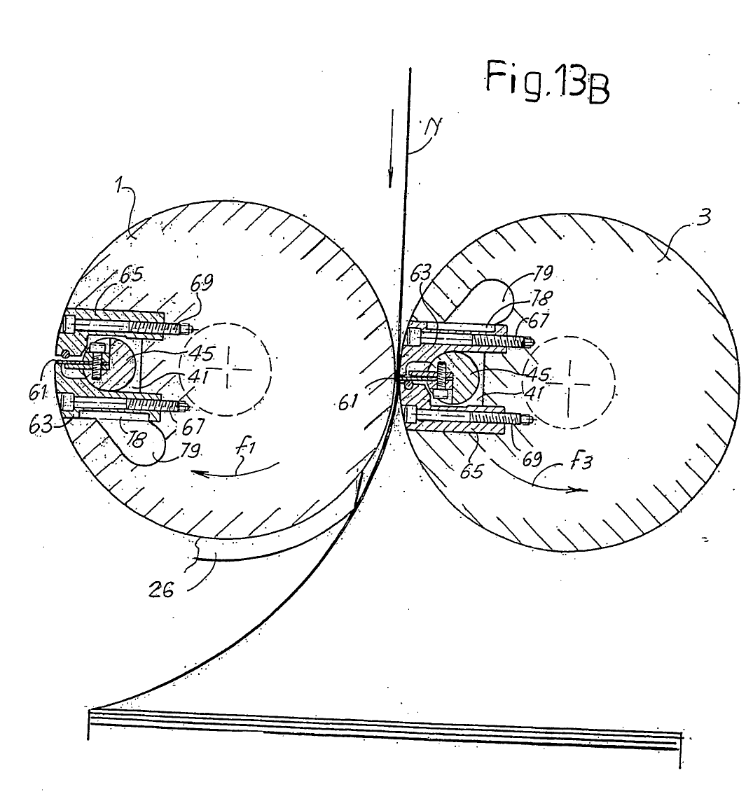

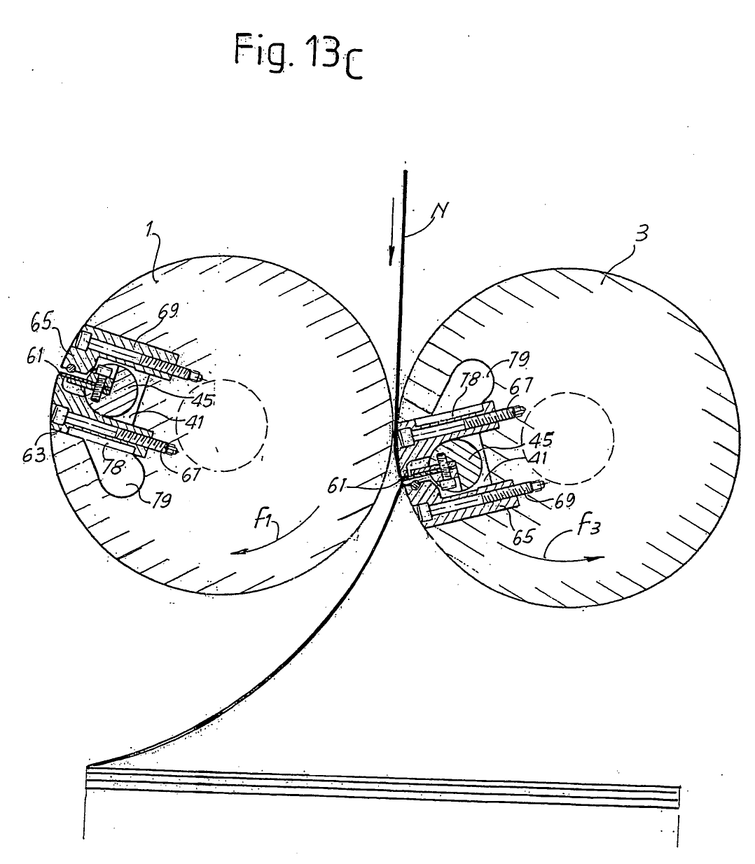

The two folding rollers 1 and 3 rotate in opposed directions as represented by the arrows f1 and f3, while the web material N (which may already be folded according to a continuous longitudinal folding line), is fed into the nip 5 between the two folding rollers. As can be seen in particular in FIGS. 5 and 6 and in the sequence in FIGS. 13A-13C, the gripping members housed in the two cavities 41 of the two folding rollers 1 and 3 are disposed in synchronized angular positions so that when the gripping member of the folding roller 3 is at the nip 5, the gripping member associated with the folding roller 1 is in a position diametrally opposite with respect to the nip between the rollers.

The two angular positions shown in FIGS. 13A and 13C are those in which suction starts and stops through the suction duct 79 associated with the folding roller 3. The angular position in FIG. 13B is intermediate between the two suction start and stop positions and corresponds to the position in which the gripping member associated with the folding roller 3 is in the nip 5 between the two folding rollers.

In the position in FIG. 13A the elastic strip 61 of the gripping member associated with the folding roller 3 is positioned, as a result of oscillation of the shaft 45 carrying it, against the elastic gasket 73, so as to leave a slit between the strip 61 and the rear stop 63C formed by the block 63. The web material N is drawn through this slit, which extends for the entire height of the folding roller 3, as a result of suction produced through the duct 79 and through the volume V (FIG. 5). The web material consequently forms a loop that is inserted between the stop 63C and the free edge of the elastic strip 61.

Continuing rotation of the folding rollers 1 and 3, while suction is maintained through the suction duct 79 in the folding roller 3, the cam 51 causes oscillation of the shaft 45 associated with said folding roller, making it rotate clockwise so that the elastic strip 61 pinches the web material, which has wedged in the slit defined by the strip 61 and by the stop 63C as a result of suction, against the stop 63C

Continuing counter-clockwise rotation of the folding roller 3, the mechanical restraint produced on the web material by the elastic strip 61 and by the stop 63C causes it to fold along a transverse line. Moving away from the nip 5 between the folding rollers 1 and 3, suction through the duct 79 associated with the folding roller 3 is interrupted and the web material is held on the surface of the folding roller 3 purely as a result of mechanical restraint. The oscillating plate 35 associated with the folding roller 3 is in its withdrawn position inside the groove 37 of the roller. Consequently, the folded web material N is carried over the curved portion of said plate. After reaching a sufficiently advanced angular position, the strip 61 is opened as a result of clockwise oscillation of the shaft 45 and the portion of folded web material is detached from the folding roller 3 by means of controlled oscillation of the plate 35. This operation to detach the web material folded by the folding roller is per se known and analogous to that of known machines.

When the folded web material is released from the folding roller 3, the gripping member carried by the folding roller 1 is moving towards the nip 5 between the folding rollers and is therefore close to the position in which suction is activated on the roller 1. An analogous folding phase performed by the folding roller 1 then starts.

It is apparent from the above description that with the suction system associated with the folding rollers 1, 3 the web material N is inserted into the gripping member formed by the strip 61 and by the stop 63C as a result of suction, without the need to provide a blade for mechanical folding. With respect to traditional machines (for example of the type described in WO-A-0162651) the machine is considerably simplified, as it is unnecessary to provide mechanical systems to control oscillations of the blade to insert the web material in the gripping member. Moreover, the absence of folding blades also allows gentler handling of the material to be folded, which is therefore less liable to undergo damage during folding.

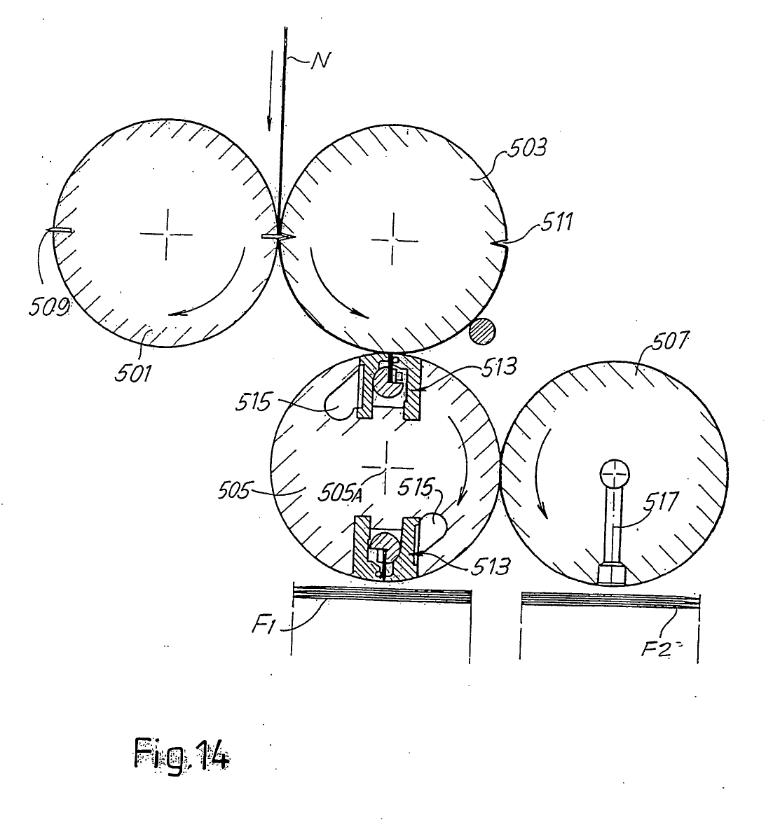

In the text hereinbefore, the invention has been described applied to a specific folding machine, provided with two folding rollers, on which the invention allows particular advantages to be attained. Nonetheless, it can also be applied to folding machines of different conformation. As an example, FIG. 14 shows a folding machine wherein the web material is cut into sheets prior to transverse folding. The machine schematically is provided with a cutting unit composed of two counter-rotating cylinders with parallel axes 501, 503. A nip is defined between these cylinders, through which the web material is fed, which may be folded longitudinally prior to transverse cutting and folding. The numbers 509 and 511 indicate pairs of blades and counter-blades carried by the two cylinders 501, 503. The web material N cut into single sheets is held on the surface of the cylinder 503 by suction holes, not shown, and the individual sheets are thereby made to enter a nip defined by the cylinder 503 and by a folding roller 505. In the example shown, this has a pair of mechanical gripping members 513 that may be produced analogously to the mechanical gripping members of the previous embodiment. The number 515 schematically indicates suction members that can in practice be produced in the same way as those described with reference to the previous figures and which have the same function of using suction to make a portion of the individual sheets of web material N enter the gripping member.

The folding roller 505, which rotates around its axis 505A, forms a nip with a distributor roller 507 that has suction holes and that is used to divide the flow of folded sheets so that they are distributed (in a way known per se) into two rows F1, F2 upon delivery from the nip between the rollers 505 and 507.

It is apparent from this schematic example that the suction system according to the invention utilized to insert a loop of web material into the gripping member to make the fold facilitates production of a machine wherein the fold is performed on the web material previously divided into portions or sheets.

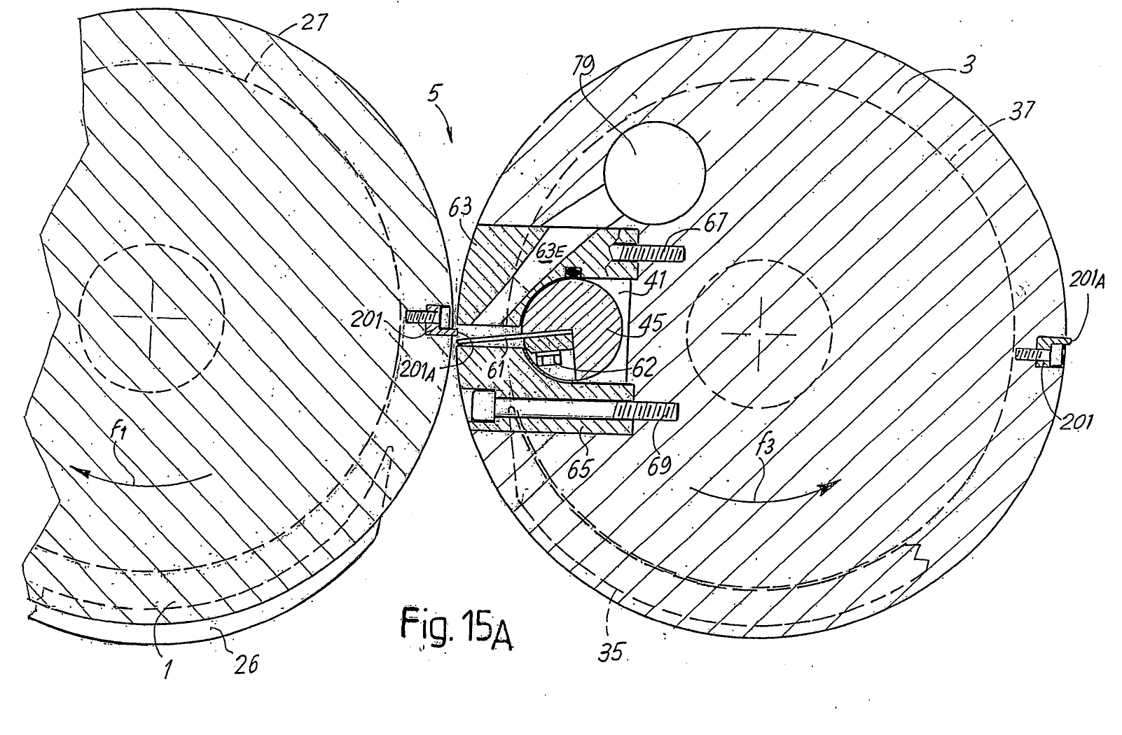

FIGS. 15A and 15B show, in two consecutive moments during rotation of the folding rollers, a plan view and partial section of the folding rollers in an improved embodiment of the invention. Equivalent numbers indicated equivalent or corresponding parts to those in the previous FIGS. 1 to 13. Besides some differences in the form of the blocks 63 and 65 housed in the cavity or seat 41, the embodiment in FIGS. 15A, 15B differs from the previous one for the different configuration of the volume V wherein suction is produced. In this case suction on the web material to be folded is exerted directly through the through holes 63E produced in the block 63 and terminating on the surface of said block against which the strip 61 nips the folded material.

The essential difference with respect to the previous embodiment, however, lies in the presence on each folding roller 1, 3, in a position diametrally opposite with respect to the seat in which the folding strip 61 is housed, of an element that facilitates start of suction of the material to be folded between the strip 61 and the block 63. This element is constituted by an insert 201 fixed in a notch of the respective roller 1 or 3, extending parallel to the axis of rotation of the roller. The number 203 indicates fixing screws. In practice, the insert 201 is divided into two portions, separated by the groove 27 or 37 of the respective roller.

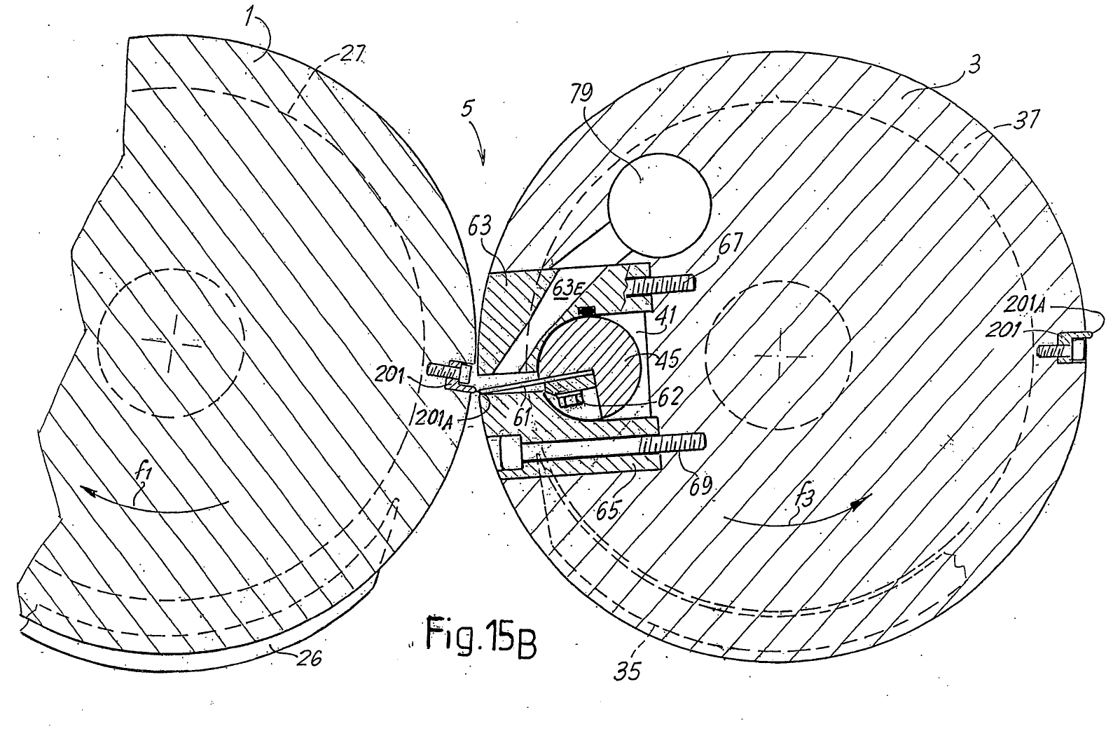

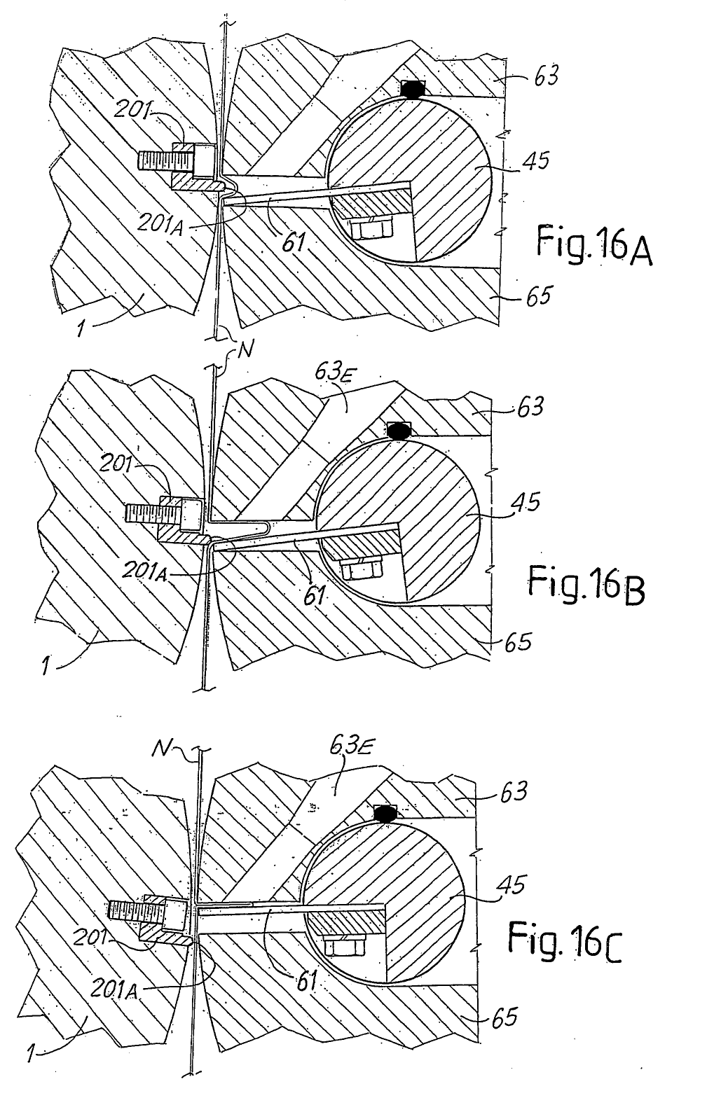

The insert 201 has a ribbing or projection 201A that projects slightly (for a few tens of millimeter, typically 0.1-0.5 mm) from the cylindrical side surface of the respective folding roller 1, 3. The two rollers 1, 3 are synchronized so that the projection 201A is carried in front of the suction compartment between the strip 61 and the block 63 of the opposed roller. In the sequence represented in FIGS. 15A, 15B two positions spaced apart in time by an extremely brief interval can be seen: in the position in FIG. 15A the projection 201A is located in front of the suction compartment and makes the web material N to be folded, when it rests on said projection, project towards the opposed roller (roller 3 in the position shown). This facilitates pick-up of the material by suction. In FIG. 15B the subsequent position is shown, in which the projection 201A (as a result of rotation of the folding roller 1) moves away from the strip 61. Said strip has not yet pinched the web material N, which has been engaged by suction and forms a loop between the block 63 and the strip 61. Therefore, contrary to the method used by known folding machines, wherein the web material is pinched by a strip acting against an insertion wedge to obtain the fold, in the configuration shown herein there is no mechanical cooperation between the blade 61 and the projection 201A, that is the web material is not gripped or pinched between strip 61 and projection 201A. The operating principle is clearly shown in the sequence in FIGS. 16A, 16B, 16C which show the two folding rollers in three consecutive angular positions while making the fold in the web material N.

The insert 201 with the projection 201A facilitates pick-up by suction of the web material by the suction device and allows even greater operating speeds to be attained. The solution can also be adopted in the configurations of the folding rollers shown in the previous figures. In the configuration with only one folding roller in FIG. 14, the insert 20 can be fitted on the cylinder 503.

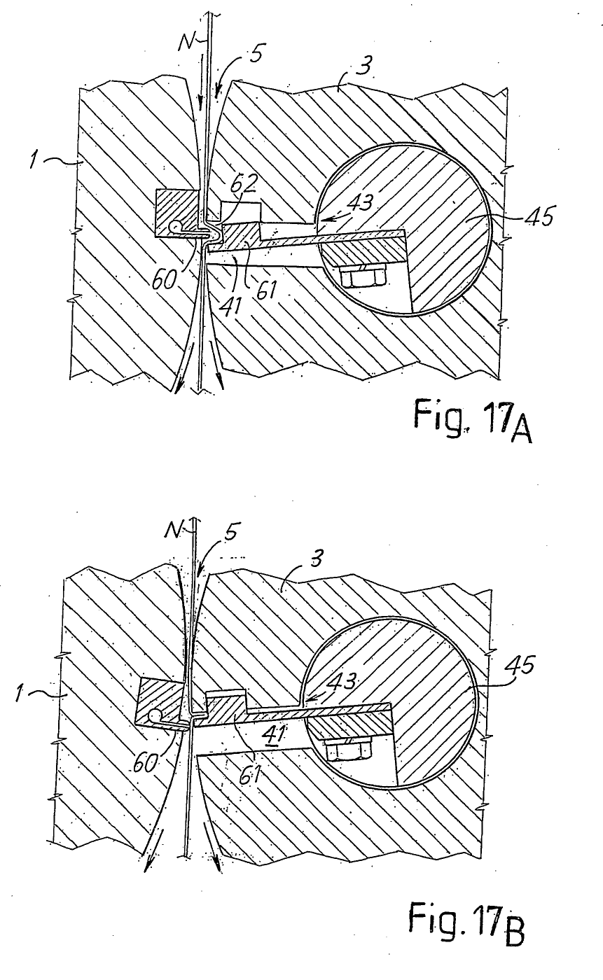

FIGS. 17A and 17B show yet a further embodiment of the invention. Similar or corresponding elements are designated with the same reference numbers as in the previous figures. Each folding roller 1, 3 has a cavity 41 into which a strip 61 is oscillatingly housed. The strip 61 is supported by an oscillating shaft 45 and forms part of the gripping member designated 43 as a whole. The strip 61 is designed to grip or grasp the web material and fold it by pinching between the strip 61 and a fixed abutment 62 extending along the opening of the seat or cavity 41 on the surface of the respective roller.

In a position diametrically opposed to the position of the gripping member formed by the strip 61 each folding roller 1, 3 is provided with a linear air nozzle 601 extending parallel to the axis of the folding roller and for approximately its entire axial length. Instead of a linear air nozzle 601, a line of individual nozzles can be provided. The nozzle is housed in a longitudinal notch in the cylindrical surface of the folding roller. Advantageously, the nozzle projects slightly, e.g. 0.1-0.5 mm, from the roller surface.

As can be seen in the figures, the position of the air nozzles 601 and of the gripping members on the two rollers 1, 3 is such that during rotation of the rollers 1, 3 a nozzle 601 of one roller faces a gripping member of the opposed roller in the nip 5 between the rollers to generate a fold in the web material N. Before reaching the position of FIG. 17A, where the two elements 601 and 61 are faced one opposed to the other in the nip N, the nozzle 601 starts to generate an air jet, e.g. by means of compressed air coming from a line of compressed air from a fan or a compressor. Flow connection between the fan and the nozzle 601 can be designed similar to the flow connection described above with respect to the previous embodiments.

When the nozzle 601 faces the gripping member, the air flow generated by the nozzle 601 pushes the web material N towards and into the gripping member, between the abutment 62 and the strip 61. A loop of web material is thus formed inside the cavity 41, between abutment 62 and strip 61. Immediately afterwards (FIG. 17B) the strip 61 is oscillated to pinch the loop of web material, N between the strip 61 and the abutment 62, thus forming the fold.

As in the previous embodiments, also in the embodiment of FIGS. 17A, 17B the web material is introduced into the gripping member without mechanical action. The slight projection of the nozzle 601 from the surface of the roller facilitates the formation of the loop, without mechanical contact between the nozzle and the gripping member.

The nozzle 601 can be connected to a fan or an air compressor through a compressed air line, similarly to what has been disclosed before with reference to the suction system and the suction line. Phasing of the air jet can also be obtained in a way similar to the one disclosed above for synchronizing the suction effect.

In the drawings the strip 61 is designed with an abutment near to its distal edge, i.e. to the edge which is farther away from the oscillation axis. This abutment provides a limitation to the dimension of the loop formed by the air flow, i.e. a limitation to the amount of web introduced into the gripping member. The abutment could be formed by the roller rather than by the strip 61. A similar arrangement can be provided also in the previously described embodiments, to limit the amount of web material sucked into the folding roller.

It is understood that the drawing purely shows a possible embodiment of the invention, the forms and layouts of which may vary without however departing from the scope of the concept on which the invention is based. The presence of any reference numbers in the appended claims has the sole purpose of facilitating their reading reference being made to the description hereinbefore and of the accompanying drawings and does not in any way limit the scope of protection.

1. Folding machine to fold a web material along transverse folding lines, comprising at least one folding roller provided with at least one gripping member to mechanically grasp the web material along a folding line; and a gaseous flow member associated with said at least one gripping member to insert the web material into said at least one gripping member.

2. Machine according to claim 1, wherein said gaseous flow member is a suction member to draw the web material towards said at least one gripping member.

3. Machine as claimed in claim 1 or 2, further comprising two counter-rotating folding rollers, with parallel axes, each of said counter-rotating folding rollers being provided with at least one gripping member.

4. Folding machine as claimed in claim 2, wherein each said suction member is associated with a device to activate and deactivate suction as a function of an angular position of a respective folding roller of said at least one folding roller, the suction member associated with each said respective folding roller being active for a fraction of a complete turn of the respective folding roller.

5. Folding machine as claimed in claim 2, wherein said at least one gripping member comprises a movable element cooperating with a first stop, the web material being sucked by said suction member between said movable element and said stop.

6. Folding machine as claimed in claim 5, wherein said movable element cooperates with a second stop, said first stop and said second stop defining a slit essentially parallel to an axis of rotation of a respective folding roller of said at least one folding roller, the movable element extending in said slit.

7. Folding machine as claimed in claim 3, wherein each of said at least one folding roller comprises at least one cavity substantially parallel to an axis of rotation and opens on a cylindrical surface of the folding roller, inside which a respective gripping member is housed, and wherein a suction duct terminates in said cavity.

8. Folding machine as claimed in claim 7, wherein each of said at least one cavity is provided with means to limit effect of suction on one side of a movable element associated with said at least one gripping member between the movable element and said first stop.

9. Folding machine as claimed in claim 8, wherein a first block defining said first stop is fixed in said cavity.

10. Folding machine as claimed in claim 6, wherein a second block defining said second stop is fixed in said cavity.

11. Folding machine as claimed in claim 9, wherein said first block delimits a suction compartment in connection with said suction duct and is provided with a plurality of suction holes distributed along a longitudinal extension of said first block and terminating on a surface of said first block positioned on an opposite side with respect to said suction compartment and facing the movable element.

12. Folding machine as claimed in claim 11, wherein said movable element is supported by a shaft oscillating around its longitudinal axis, supported in said cavity, and in that wherein said first block has a sealing surface cooperating with said oscillating shaft, said holes terminating between the first stop defined by said first block and said sealing surface.

13. Folding machine as claimed in claim 12, wherein each of said at least one gripping member includes an elastic strip.

14. Folding machine as claimed in claim 13, wherein said elastic strip is integral with said oscillating shaft and cooperates with said first stop.

15. Folding machine as claimed in claim 3, wherein each of said counter-rotating folding rollers is associated with a sliding block with a communication channel between a suction line and a suction duct in a respective folding roller of said at least one folding roller, said sliding block resting on a sliding surface of the respective folding roller.

16. Folding machine as claimed in claim 15, wherein said sliding surface is disposed on a front surface of the respective folding roller on which said suction duct terminates.

17. Folding machine as claimed in claim 15, said sliding block is resiliently pushed against said sliding surface.

18. Folding machine as claimed in claim 15, wherein said sliding block has an elongated aperture communicating with the respective folding roller.

19. Folding machine as claimed in claim 4, wherein each said device to activate and deactivate suction is adjustable, to adjust positions in which suction is opened and closed as a function of the angular position of the respective folding roller.

20. Folding machine as claimed in claim 15, wherein said sliding block is disposed in a specific angular position adjustable with respect to the respective folding roller.

21. Folding machine as claimed in claim 20, wherein said sliding block is engaged with a flange coaxial to the respective folding roller, the angular position of which around the axis of the folding roller is adjustable.

22. Folding machine as claimed in claim 1, further comprising a cutting unit that cuts the web material into single sheets, which are folded by said folding roller, is associated with said folding roller.

23. Folding machine as claimed in claim 22, wherein said cutting unit has two counter-rotating cylinders with axes parallel to each other and to the folding roller, which define between them a nip through which the web material is fed, and provided with blades and counter-blades to cut the web material and wherein one of said two counter-rotating cylinders forming the cutting unit forms with the folding roller a nip through which the cut web material is fed.

24. Folding machine as claimed in claim 1, wherein said at least one folding roller cooperates with a counter-roller on which a projection is provided extending parallel to the axis of said rollers, the position of said projection being synchronized with respect to the position of said gripping member, to facilitate pick-up of said web material by suction.

25. Folding machine as claimed in claim 24, wherein a corresponding projection is provided on each of said at least one folding roller, each projection of one of said at least one folding roller cooperating with a gripping member of the opposite folding roller.

26. Folding machine as claimed in claim 1, wherein said gaseous flow member includes an air ejection member, to push the web material inside said at least one gripping member.

27. Folding machine as claimed in claim 26, wherein on each said at least one folding roller an air ejection member and a gripping member are provided, arranged on diametrically opposed positions.

28. Folding machine as claimed in claim 26, wherein said gaseous flow member includes at least one air nozzle.

29. Folding machine as claimed in claim 28, wherein said at least one air nozzle is a linear nozzle extending parallel to the axis of the at least one folding roller.

30. A method for folding a web material according to transverse folding lines, comprising:
providing at least one folding roller;
providing on said at least one folding roller at least one gripping member;
rotating said at least one folding roller around its axis;
feeding the web material to said at least one folding roller;
engaging the web material with said at least one gripping member of said at least one folding roller; wherein the web material is inserted into said at least one gripping member by means of a gaseous flow.

31. Method as claimed in claim 30, wherein said web material is inserted into said at least one gripping member by suction.

32. Method as claimed in claim 30, wherein said web material is inserted into said at least one gripping member by means of an air jet.

33. Method as claimed in claim 30 or 31 or 32, further comprising two counter-rotating folding rollers with parallel axes, which define a nip through which the web material is fed, each of said at least one folding roller being provided with one of said at least one gripping member, and wherein the web material is engaged alternately with a first one of said at least one gripping member of a first one of said at least one folding roller and with a second one of said at least one gripping member of a second one of said at least one folding roller, to fold said web material in a zigzag.

34. Method as claimed in claim 33, wherein activating the gaseous flow associated with each of said at least one gripping member in an angular position of a respective folding roller upstream of the nip between the first one of said at least one folding roller and a second one of said at least one folding roller, and deactivating said gaseous flow after the web material has been engaged by the respective gripping member.

35. Method as claimed in claim 34, wherein said gaseous flow is deactivated when the respective gripping member has passed beyond the nip between said first one of said at least one folding roller and said second one of said at least one folding roller.

36. Method as claimed in claim 30, further comprising pinching the web material between a stop fixed with respect to a respective one of the at least one folding roller, and a movable element.

37. Method as claimed in claim 36, wherein said gaseous flow is concentrated between the stop and said movable element.

38. Method as claimed in claim 30, further comprising facilitating of formation of a fold in said web material in front of said at least one gripping member.

39. Method as claimed in claim 38, wherein folding is facilitated by a projection provided on a roller positioned opposite to said first one of said at least one first folding roller.

40. Method as claimed in claim 39, wherein said gripping member does not cooperate mechanically with said projection.
